(19) United States
(12) Patent Application Publication
(10) Pub. No.: US 2005/0153147 A1
(43) Pub. Date: Jul. 14, 2005

(54) Ink-jet media having flexible radiation-cured and ink-receptive coatings

(75) Inventors: Khizyr K. Khoultchaev, Branford, CT (US); Michael Wang, Vernon Hills, IL (US); Cau T. Ho, East Haven, CT (US); Robert M. Conforti, Wakefield, RI (US); James A. Foley, Wellesley, MA (US)

Correspondence Address: BARLOW, JOSEPHS & HOLMES, LTD., 101 DYER STREET, 5TH FLOOR, PROVIDENCE, RI, 02903, US

(73) Assignee: Arkwright, Inc.

(21) Appl. No.: 11/032,242

(22) Filed: Jan. 10, 2005

Related U.S. Application Data
(60) Provisional application No. 60/536,432, filed on Jan. 14, 2004.

(51) Int. Cl. C08G 2/00; B32B 27/06

(52) U.S. Cl. 428/480; 522/1

(57) ABSTRACT

An improved ink-jet recording medium comprising a base paper substrate coated with a radiation-curable layer having a relatively low glass transition temperature (Tg) and at least one ink-receptive layer is provided. The radiation-curable layer can be cured with UV-light radiation. The ink-receptive layers are coated over the radiation-cured layer. The radiation-cured layer is generally flexible so that the resulting ink-jet recording medium can be handled and packaged easily. The ink-jet recording medium can be printed with images using ink-jet printers. The medium has improved ink-drying times and ink-smudge resistance.

### CROSS-REFERENCE TO RELATED APPLICATIONS

This application claims the benefit of U.S. Provisional Application No. 60/536,432 having a filing date of Jan. 14, 2004, the entire contents of which are hereby incorporated by reference.

### BACKGROUND OF THE INVENTION

1. Field of the Invention

The present invention relates to imaging media suitable for use with ink-jet printers. More particularly, the invention relates to ink-jet recording media made from a paper substrate that is coated with a radiation-curable composition and at least one ink-receptive composition.

2. Brief Description of the Related Art

Ink-jet printing systems that produce color images on papers, films, non-woven fabrics, and other recording media are commonly used today. These systems employ certain digital technologies, inks, and ink-jet printers to produce high quality prints. In many instances, an inkjet “photo paper” is used as the recording medium. The market for photo papers continues to grow, because of their ability to record high quality digital photographic images. These photo papers are coated with specially designed ink-receptive coatings that receive the ink and produce colored images. The photo papers can be used in a variety of applications such as indoor signs, posters, advertising banners, and other display graphics. Narrow and wide format color ink-jet printers are used to produce the imaged products depending upon the size of the media and intended end-use application.

Most inks used in such ink-jet printers are aqueous-based inks containing water as their primary component. The aqueous-based inks contain molecular dyes or pigmented colorants. During printing, dyes or colorants from the ink penetrate into the ink-receptive coatings on the medium. Water and other solvents, if present, evaporate from the printed medium as the medium is dried.

Paper substrates such as clay-coated or polyethylene resin-coated papers are often used to make ink-jet photo papers. These paper substrates, however, have some disadvantageous properties. For example, polyethylene-coated papers can be relatively expensive and it may be difficult to use polyethylene-coated papers in high temperature manufacturing operations. The cost of clay-coated papers is generally lower than polyethylene-coated papers. But, clay-coated papers tend to absorb the aqueous ink vehicle and this absorption may lead to curling of the paper's edges and cockling of the paper's surface.

Recently, the ink-jet industry has turned to making an ink-jet photo paper comprising a paper substrate, radiation-cured layer which overlays the paper substrate, and a polymeric ink-receptive layer which overlays the radiation-cured layer. These imaging media can absorb aqueous-based inks and the inks tend not to permeate into the base paper substrate. In addition, the radiation-cured layer has generally good thermal stability.

For example, Xing et al., U.S. Pat. No. 6,610,388 discloses ink-jet recording media which are coated with a radiation-curable composition and an ink-receptive composition. The radiation-curable coating is cured preferably by UV-light irradiation. The media have a water vapor transmission rate of no greater than 12 grams/100 square inches/24 hours and preferably have a surface gloss of at least 70.

Published U.S. Patent Application No. 2002/0182376 (Mukherjee et al.) discloses ink jet media having an ultraviolet-light or electron beam cured barrier layer. Multiple ink receptive layers are coated over the barrier. The first layer is based upon gelatin and/or polyvinyl alcohol (PVOH) chemistries. The next ink receptive layer is based upon pigmented, cellulose chemistry.

Miklasiewicz, U.S. Pat. No. 6,326,415 discloses an ink jet recording material having a support substrate. The support substrate is coated with a UV-cured resinous layer, and the coating layer is prepared from a formulation containing a tetrafunctional polyester acrylate, a difunctional acrylic ester, a UV photoinitiator and a polyether.

Nemoto et al., European Patent EP 0 770 493 discloses an ink-jet recording material comprising: (1) a support sheet comprising a substrate sheet and a resinous coating layer which is formed on the surface of the substrate sheet and comprises a radiation-cured product, and (2) an ink-receiving layer formed on at least one surface of the support sheet. In the preferred method of forming the resinous coating layer, a surface of the coating liquid layer is brought into contact with a smooth casting surface of a casting member, and under this condition, a radiation is applied to the coating liquid layer to cure it.

Although some ink-jet media having a radiation-cured barrier layer have some desirable properties, there is a need for ink-jet media having improved radiation-cured barrier layers. The cured layer should be have good mechanical integrity and be generally flexible so that cracks do not form in the layer when the media are used in various end-use applications. Furthermore, the media should be capable of producing high quality prints from dye and pigmented inks over a broad range of ink loadings and temperature and humidity conditions. The printed images produced on the media should dry quickly and display good color brilliance, sharpness, and fidelity. The present invention provides such media. These and other objects, features, and advantages of this invention are evident from the following description and attached drawings.

### SUMMARY OF THE INVENTION

The present invention relates to an ink-jet recording medium comprising: a) a paper substrate, b) a radiation-cured layer overlaying a surface of the paper substrate, and c) at least one ink-receptive layer overlaying the radiation-cured layer. The radiation-cured layer has a relatively low glass transition temperature (Tg), preferably less than 25° C. Preferably, a first ink-receptive layer (or underlayer) is applied over the radiation-cured layer, and then a second ink-receptive layer (or top layer) is applied over the first ink-receptive layer. In one embodiment, the first ink-receptive layer comprises a blend of an acrylic copolymer having a Tg of greater than 25° C.; poly(vinyl alcohol); and poly(vinyl pyrrolidone). The acrylic-acid styrene copolymer preferably has a high acid number.

In one embodiment, the paper substrate is a clay-coated paper having a thickness in the range of about 4 to about 8 mils. The radiation-cured layer can be formed by irradiating a coating comprising a radiation-curable oligomer and photoinitiator. The coating can further comprise radiation-curable monomer and additives. Suitable oligomers include, for example, acrylated polyethers, acrylated polyesters, and acrylated acrylics. The oligomers preferably have a relatively low glass transition temperature (Tg), particularly less than 25° C. Generally, the radiation-cured layer has a weight in the range of about 1 to about 40 grams/square meter. Ultraviolet light or electron beam irradiation can be used to cure the coating.

The radiation-cured barrier layer of this invention is generally flexible so that the resulting ink-jet recording medium can be handled and packaged easily. The ink-jet recording medium can be printed with images using conventional ink-jet printers. The ink-jet medium has improved ink-drying times and ink-smudge resistance. Thus, images having good color density, brilliance, and resolution can be produced.

### BRIEF DESCRIPTION OF THE FIGURE

FIG. 1 is a schematic side view of one embodiment of the ink-jet recording medium of this invention.

### DETAILED DESCRIPTION OF THE PREFERRED EMBODIMENTS

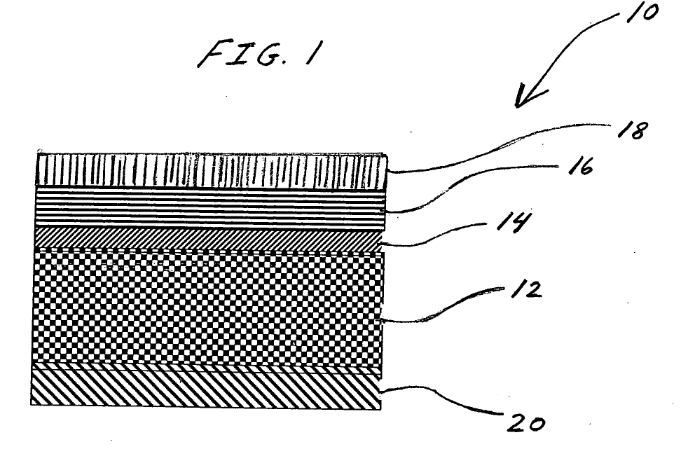

Referring to FIG. 1, the ink-jet recording medium of this invention is generally indicated at (10). The ink-jet recording medium (10) comprises a paper substrate (12) having two surfaces. The first surface, which is coated with radiation-cured barrier layer (14) and ink-receptive layers (16, 18) may be referred to as the “front” or “imaging” surface. The second surface of the paper substrate (12), which is opposite to the first surface, may be coated with a back-coating (20) and may be referred to as the “back” or “non-imaging” surface. The individual components of the ink-jet recording medium (10) are described in further detail below.

A. Paper Substrate

Paper substrates (12) are known generally in the inkj et industry, and any suitable paper substrate (12) may be used to make the ink-jet media (12) of the present invention. For example, plain papers, clay-coated papers, or resin-coated papers may be used. Preferably, the paper is a clay-coated paper. The base weight of the paper is not particularly restricted, but it generally should be in the range of about 80 grams per square meter (gsm) to about 250 gsm, preferably in the range of 130 gsm to 180 gsm. The thickness of the paper is not particularly restricted, but it generally should be in the range of about 4 mils to about 8 mils. The paper substrate may be pre-treated with conventional adhesion promoters or a primer coating to enhance adhesion of the radiation-cured barrier layer and ink-receptive coated layers to the paper.

B. Radiation-Cured Barrier Layer

A radiation-curable coating is applied to the paper substrate (12), and this coating is cured to form a radiation-cured layer (14) as shown in FIG. 1. The radiation-curable coating may comprise radiation-curable oligomers and monomers such as acrylated oligomers, multifunctional acrylate monomers, difunctional and monofunctional monomers, and mixtures thereof as described in the above-mentioned Xing et al., U.S. Pat. No. 6,610,388, the disclosure of which is hereby incorporated by reference. In the present invention, the radiation-curable coating is an improved coating and comprises an oligomer such as an urethane-based oligomer, acrylated polyester, or acrylate-based oligomer having a relatively low glass transition (Tg) temperature.

More particularly, the radiation-cured barrier layer of this invention preferably has a Tg of less than 25° C. The radiation-cured barrier layer exhibits several improvements over conventional radiation-cured barrier layers. Particularly, the radiation-cured barrier layer has improved flexibility at low relative humidity (RH) conditions. While conventional radiation-cured barrier layers can be somewhat brittle causing cracks to form therein, the radiation-cured barrier layer of this invention is generally flexible. As a result, the coated ink-jet recording medium can be bent and twisted without generating cracks. In addition, the radiation-cured layer has improved adhesion to the ink-receptive layers that overlay the cured layer. These ink-receptive layers are described further below.

The resulting radiation-cured layer also has good thermal stability. The ink-receptive layers can be applied to the radiation-cured layer, and these coated layers can be processed subsequently without distorting or damaging the radiation-cured layer. The thermal stability of the radiation-cured layer can permit a more quickly and complete drying of the subsequently coated ink-receptive layers. In addition, this thermal stability can allow for important chemical reactions to occur during the processing of the media, for example, cross-linking of the ink-receptive layers.

Radiation from an electron beam or ultraviolet (UV) light source is used to cure the wet radiation-curable coating. The radiation induces the formation of free radicals that initiate polymerization of the oligomers. In electron beam radiation, a barrage of electrons initiates the free radical polymerization. In ultraviolet (UV) light radiation, photoinitiators (photosensitizers) absorb the UV light and initiate the free radical polymerization. Preferably, UV light radiation is used to cure the coating, and the coating formulation further comprises a photoinitiator. The coating may also contain additives such as inhibitors, surfactants, waxes, cure accelerators, defoaming agents, pigments, dispersing agents, optical brighteners, UV light stabilizers (blockers), UV absorbers, adhesion promoters, and the like.

In practice, the radiation-curable oligomers are blended together with a photoinitiator and any desired additives to form the coating formulation that will be applied to the paper substrate. The mixture may be heated to reduce its viscosity. The coating formulation may be applied to the base paper by a conventional coating method to form a uniform layer thereon. Suitable methods for coating the base paper include, for example, Meyer-rod, roller, blade, wire bar, dip, solution extrusion, air-knife, curtain, slide, doctor-knife, and gravure methods. As mentioned above, UV light radiation may be used to cure the wet coating. Generally, the UV light has a wavelength in the range of about 200 nm to about 400 nm. Commercial UV light curing equipment may be used. Such equipment typically includes an UV light source (e.g., a tubular glass lamp), reflectors to focus or diffuse the UV light, and a cooling system to remove heat from the lamp area. After curing, the paper may be treated with corona discharge to improve its adhesion to the ink-receptive layers.

C. Ink-Receptive Underlayer

In the present invention, the paper substrate (12), which is coated with the radiation-cured barrier layer (14) as described above, is coated further with multiple ink-receptive layers (16, 18). First, an ink-receptive intercoat or underlayer (16) is coated over the radiation-cured layer (14). This underlayer (16) is referred to as “Ink-Receptive Layer I” in the below examples.

The ink-receptive underlayer (16) can be prepared from a coating formulation comprising water-soluble and/or water-dispersible resins. Suitable water-soluble resins include, for example, those selected from the group consisting of polyvinyl alcohols; modified polyvinyl alcohols; poly(vinyl pyrrolidone); vinyl pyrrolidone copolymers; poly(2-ethyl-2-oxazoline); poly(ethylene oxide); poly(ethylene glycol); poly(acrylic acids); starch; modified starch; cellulose; cellulose derivatives; alginates and water-soluble gums; dextrans; carrageenan; xanthan; chitin; proteins; gelatins; agar; and mixtures thereof. Suitable water-dispersible resins include, for example, those selected from the group consisting of polyvinyl chloride; vinyl chloride copolymers (e.g., ethylene-vinyl chloride); polyvinylidene chloride; vinylidene chloride copolymers; acrylates; methacrylates; polyvinyl acetate; vinyl acetate copolymers (e.g., ethylene-vinyl acetate copolymers, and acrylic-vinyl acetate copolymers,) polyacrylonitrile; polystyrene; styrene copolymers (e.g., styrene-maleic acid anhydride copolymers and styrene-butadiene copolymers); rubber latex; polyesters; vinyl-acrylic terpolymers, polyacrylonitrile; acrylonitrile copolymers (e.g., butadiene-acrylonitrile copolymers, butadiene-acrylonitrile-styrene terpolymers); polyurethanes; and mixtures thereof.

Preferably, the ink-receptive underlayer (16) comprises a blend of an acrylic acid-styrene copolymer having a relatively high glass transition temperature (Tg); poly(vinyl alcohol) (PVOH); and poly(vinyl pyrrolidone) (PVP). Particularly, a blend comprising an acrylic copolymer having a Tg of greater than 25° C.; PVOH; and PVP can be used to form the ink-receptive underlayer (16). For example, the acrylic-styrene copolymer, “Joncryl 538” available from Johnson Polymers, has a relatively high Tg of 64° C. Furthermore, the acrylic-acid styrene copolymer preferably has a high acid number, preferably greater than 25, and more preferably greater than 50. For example, the “Joncryl 538” acrylic-styrene copolymer has an acid number of 53. This higher acid functionality may help improve the interface adhesion of the ink-receptive layers and prevent intermixing of the ink receptive top layer (18) with the ink-receptive underlayer (16). The improved interface adhesion of the ink-receptive layers (16, 18) helps enhance the ink smudge-resistance of the ink-jet medium (10). Also, it is believed that this blend of materials in the ink-receptive underlayer contributes to the relatively fast ink-drying times of the medium. Without wishing to be bound by any particular theory, it is thought that this decrease in ink drying-time may be due to the capillary flow of ink through voids formed between phase-separated micro-domains of polymer which are created when these particular classes of polymeric materials are combined. It also is believed that this beneficial effect may be observed when combining other classes of materials having similar refractive indices with the PVOH/PVP mixture that forms the phase-separated micro-domains.

The above-described conventional coating methods, which are used to apply the radiation-curable coating layer to the paper substrate, also may be used to apply the ink-receptive underlayer over the radiation-cured layer. Then, the coated substrate is placed in a forced hot air oven to dry the coated ink-receptive underlayer. After the underlayer has been dried, an ink-receptive top layer is coated over the underlayer.

D. Ink-Receptive Top Layer

An ink-receptive top coat (18) is applied over the ink-receptive underlayer (16) and dried accordingly. In general, the above-described water-soluble and/or water-dispersible resins, which are used to prepare the ink-receptive underlayer (16), can also be used to prepare the ink-receptive top coat (18). Preferably, the top coat (18) comprises cellulose or cellulose derivatives such as methyl cellulose, methyl propyl cellulose, hydroxyethylcellulose, hydroxypropylcellulose, hydroxyethyl methyl cellulose, hydroxypropyl methyl cellulose, hydroxybutyl methyl cellulose and the like; polyurethanes; alumina pigment, and a cross-linking agent such as zirconyl chloride (ZrOCl₂)/HCL This top coat (18) is referred to as “Ink-Receptive Layer II” in the below examples. The cross-linked top layer is a relatively tough coating that helps to improve the ink-drying times and ink smudge-resistance of the printed medium. It is believed that the pigmented ink, which is applied to the medium in the printing process, better adheres to these ink-receptive layers. As a result, the imaged ink dries relatively quickly and the ink tends not to smudge.

It is understood that the ink-receptive underlayer (16) and/or top layer (18) may contain additives such as pigments, surface active agents that control the wetting or spreading action of the coating, anti-static agents, suspending agents, acidic compounds to control the pH of the coating, optical brighteners, UV light stabilizers, UV absorbers, de-foaming agents, humectants, waxes, plasticizers, and the like. The total dry coat weight of the ink-receptive layers is typically in the range of about 5 to about 40 g/m².

E. Coating of Back Surface of Paper Substrate

In addition, the back surface of the paper substrate (12) may be coated with a polymeric layer (20) that further helps prevent moisture from penetrating into the base paper (12). The polymeric coating on the back surface of the paper (12) enhances the paper's dimensional stability and helps minimize paper curling, cockling, and other defects. In one embodiment, a polymeric coating (20) comprising a water soluble or water-dispersible film-forming resin may be prepared. An aqueous coating formulation containing the film-forming resin may be prepared and applied to the back surface of the base paper using the coating methods described above. In other embodiments, the polymeric coated layer (20) on the back surface of the paper (12) is a radiation-cured layer prepared from a coating containing radiation-curable oligomers, monomers, photoinitiators and additives as described above. If a polymeric coating is applied to the back surface of the paper, the dry coat weight of the polymeric layer is generally in the range of about 5 to about 40 gsm, and the preferable weight is about 15 to about 25 gsm.

The resulting ink-jet recording media can be imaged by narrow and wide format ink-jet printers with pigmented or dye color inks to provide high quality images. The ink-jet recording media of this invention offer several improvements over conventional inkjet recording media. Particularly, the radiation-cured barrier layer is flexible so the media can be printed and packaged easily, and used in a wide variety of applications. Cracks are less likely to form in the radiation-cured layer of the ink-jet media during handling and packaging. The ink-receptive layers provide the media with improved ink drying times and ink-smudge resistance. Thus, the media can generate high-quality prints having high color brilliance, sharpness, and fidelity.

Also, the resulting ink-jet recording medium may be produced so that it has a glossy surface luster. In such glossy media embodiments, the surface gloss is at least 70, and it is more preferably in the range of about 85 to about 95. In other embodiments, satin-like media having surface gloss values in the range of 20 to 70 can be made. In still other embodiments, matte-like media having surface gloss values less than 20 can be made. The surface gloss of the media can be measured using a Micro Tri-Gloss Meter (available from BYK Gardner, Inc.) according to the standard procedures described in the instrument manual provided by the manufacturer.

The present invention is further illustrated by the following examples using the below-described test methods, but these examples should not be construed as limiting the scope of the invention.

### EXAMPLES

The following radiation-curable coating formulations were prepared.

### Example 1

| | | | Acid | Tg | | |
|---|---|---|---|---|---|---|
| Supplier | Wt % | Chemistry | Functionality | (° C.) | Flexibility | W.V.T |
| Sartomer | 55 | Aliphatic polyester based | 2 | −10 | 4.7 | 4.69 |
| | | urethane | | | | |
| Sartomer | 20 | Polyester Acrylate | — | −45 | | |
| Sartomer | 20 | Aliphatic diacrylate | 2 | — | | |
| Sartomer | 5 | Photoinitiator | — | — | | |

### Example 2

| | | | Acid | Tg | Flexi- | |
|---|---|---|---|---|---|---|
| Supplier | Wt % | Chemistry | Functionality | (° C.) | bility | W.V.T |
| Sartomer | 75 | Acrylic Ester | 2 | −25 | 4.7 | 6.32 |
| Sartomer | 20 | Polyester | — | −45 | | |
| | | Acrylate | | | | |
| Sartomer | 5 | Photoinitiator | — | — | | |

### Example 3

| | | | Acid | | | |
|---|---|---|---|---|---|---|
| Supplier | Wt % | Chemistry | Functionality | Tg (° C.) | Flexibility | W.V.T |
| Sartomer | 55 | Polyester based urethane | 2 | −10 | 4.6 | 3.46 |
| | | diacrylate | | | | |
| Sartomer | 12.8 | Polyester Acrylate | 4 | — | | |
| Sartomer | 7.2 | Trimethylolpropane | 3 | −2 | | |
| | | Triacrylate | | | | |
| Sartomer | 20 | Polyester Acrylate | — | −45 | | |
| Sartomer | 5 | Photoinitiator | — | — | | |

### Comparative Example A

| | | | Acid | | | |
|---|---|---|---|---|---|---|
| Supplier | Wt % | Chemistry | Functionality | Tg (° C.) | Flexibility | W.V.T |
| Sartomer | 35 | Polyester Acrylate | 4 | — | 1 | 2.65 |
| Sartomer | 20 | Trimethylolpropane | 3 | 62 | | |
| | | Triacrylate | | | | |
| UCB | 40 | Polyester Acrylate | 4 | 32 | | |
| Sartomer | 5 | Photoinitiator | — | — | | |

### Comparative Example B

| | | | Acid | | | |
|---|---|---|---|---|---|---|
| Supplier | Wt % | Chemistry | Functionality | Tg (° C.) | Flexibility | W.V.T |
| Sartomer | 12.8 | Polyester Acrylate | 4 | — | 4 | 3.06 |
| Sartomer | 7.2 | Trimethylolpropane | 3 | 62 | | |
| | | Triacrylate | | | | |
| UCB | 20 | Polyester Acrylate | 4 | 32 | | |
| | | Acrylated Aliphatic | | | | |
| UCB | 55 | Urethane | 2 | 14 | | |
| Sartomer | 5 | Photoinitiator | — | — | | |

The radiation-curable coatings, as described above in Examples 1-3 and Comparative Examples A-B, were applied to the front surface of a paper substrate. The wet coating was cured by a UV light-curing system. The radiation-cured samples were subjected to a 180 degree folding test performed at 20% Relative Humidity (RH) and a temperature of 60° F. Then, the samples were visually inspected to determine flexibility and given a flexibility rating in the range of 0 to 5. On the scale of 0 to 5, radiation-cured layers having a rating of 5 were considered to have the highest level of flexibility, and radiation-cured layers having a rating of 0 were considered to have the lowest level of flexibility. Properties such as cracking sounds, the shape of the sample, and damage to the sample were considered in providing the ratings. W.V.T. refers to the water vapor transmission coefficient of the samples, and this property was measured according to standard ASTM methods.

The following ink-receptive coating formulations were prepared and applied over the radiation-cured layers, as described in above Examples 1-3 and Comparative Examples A-B. The ink-receptive coatings were applied using a Meyer rod and dried to produce an ink-jet recording medium having an ink-receptive underlayer and top layer.

Ink-Receptive Layer I (Underlayer)

(Formulation of Ink-Receptive Layer I which is Applied Over Radiation-Cured Layers of Examples 1-3)

| Ingredient | Parts | Chemistry | Supplier |
|---|---|---|---|
| Water | 25.5 | | |
| PVP K-60 | 11 | Polyvinyl Pyrrolidone | ISP |
| PVA sol | 55 | Polyvinyl alcohol | Celanese |
| BYK 380 | 0.5 | Fluorine modified acrylic | BYK Chemie |
| Joncryl 538 | 8 | High Tg Acrylic emulsion | Johnson Polymer |

Formulation of Ink-Receptive Layer I which is Applied Over Radiation-Cured Layers of Comparative Examples A and B

| Ingredient | Parts | Chemistry | Supplier |
|---|---|---|---|
| Water | 46.5 | | |
| PVP K-60 | 18 | Polyvinyl Pyrrolidone | ISP |
| PVA sol | 23 | Polyvinyl alcohol | Celanese |
| BYK 380 | 0.5 | Fluorine modified acrylic | BYK Chemie |
| Sancure 815 | 12 | Polyurethane emulsion | Noveon |

Ink-Receptive Layer II (Top Layer)

(Formation of Ink-Receptive Layer II which is Applied Over Ink-Receptive Layer I of Examples 1-3)

| Ingredient | Parts | Chemistry | Supplier |
|---|---|---|---|
| Water | 66.5 | | |
| Methocel E-15 | 6 | Methyl Propyl Cellulose | Dow |
| Dispal 23N4-20 | 23 | Alumina Dispersion | Sasol |
| Witcobond 213 | 4.5 | Polyurethane emulsion | Crompton |
| Zirconyl Chloride | 0.5 | Zirconyl oxychloride/HCL | Aldrich |
| BYK 380 | 0.5 | Fluorine modified acrylic | BYK Chemie |

Formulation of Ink-Receptive Layer II which is Applied Over Ink-Receptive Layer I of Comparative Examples A and B

| Ingredient | Parts | Chemistry | Supplier |
|---|---|---|---|
| Water | 67 | | |
| Methocel E-15 | 4.5 | Methyl Propyl Cellulose | Dow |
| Methocel K3 | 1.5 | Methyl Propyl Cellulose | Dow |
| Dispal 23N4-20 | 23 | Alumina Dispersion | Sasol |
| Witcobond 213 | 4.5 | Polyurethane emulsion | Crompton |
| BYK 380 | 0.5 | Fluorine modified acrylic | BYK Chemie |

It is appreciated by those skilled in the art that various changes and modifications can be made to the illustrated embodiments, description, and examples herein without departing from the spirit of the present invention. All such modifications and changes are intended to be covered by the appended claims.

1. An ink-jet recording medium comprising:
a) a paper substrate having a surface;
b) a radiation-cured layer overlaying the surface of the paper substrate, said radiation-cured layer formed by irradiating a coating comprising a radiation-curable oligomer and a photoinitiator, the radiation-cured layer having a glass transition temperature (Tg) of less than 25° C.; and
c) at least one polymeric ink-receptive layer overlaying the radiation-cured layer.

2. The ink-jet recording medium of claim 1, wherein the paper substrate is a clay-coated paper.

3. The ink-jet recording medium of claim 1, wherein the paper substrate has a thickness in the range of about 4 mils to about 8 mils.

4. The ink-jet recording medium of claim 1, wherein the radiation-curable oligomer is selected from the group consisting of acrylated polyethers, acrylated polyesters, and acrylated acrylics, and the oligomer has a glass transition temperature (Tg) of less than 25° C.

5. The ink-jet recording medium of claim 1, wherein the coating further comprises a radiation-curable monomer.

6. The ink-jet recording medium of claim 1, wherein the coating further comprises an additive selected from the group consisting of inhibitors, surfactants, waxes, cure accelerators, defoaming agents, pigments, optical brighteners, UV light stabilizers, and mixtures thereof.

7. The inkjet recording medium of claim 1, wherein the weight of the radiation-cured layer is in the range of about 1 to about 40 grams/square meter.

8. The ink-jet recording medium of claim 1, wherein a first and second polymeric ink-receptive layer overlay the radiation-cured layer, the second ink-receptive layer being a top layer that overlays the first ink-receptive layer.

9. The ink-jet recording medium of claim 1, wherein the first ink-receptive layer comprises a blend of an acrylic copolymer having a Tg of greater than 25° C.; poly(vinyl alcohol); and poly(vinyl pyrrolidone).
